(19) United States
(12) Patent Application Publication
(10) Pub. No.: US 2008/0023600 A1
(43) Pub. Date: Jan. 31, 2008

(54) System and Method for Mounting User Interface Devices

(76) Inventor: Marshal H. Perlman, Portola Hills, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/828,193

(22) Filed: Jul. 25, 2007

Related U.S. Application Data
(60) Provisional application No. 60/833,524, filed on Jul. 25, 2006.
(60) Provisional application No. 60/833,988, filed on Jul. 28, 2006.
(60) Provisional application No. 60/836,535, filed on Aug. 8, 2006.

(51) Int. Cl. F16M 11/00

(52) U.S. Cl. 248/128

(57) ABSTRACT

A mounting system suitable for use with user interface devices and methods for manufacturing and using same. The mounting system can be installed at any suitable location and, once installed, can receive and engage a selected user interface device. The user interface device thereby can select and present viewing content and, when not in use, can be stowed in a manner that does not interfere with the user. Being provided as modular units, a malfunctioning user interface device can be easily removed from the mounting system and replaced with another user interface device, minimizing inconvenience to the user and facilitating repairs. Since the user interface devices are produced with a common form factor, each user interface device can, without modification, be received by, and engaged by, any other installed mounting system. Thereby, only one version of the user interface device needs to be produced, purchased, and inventoried.

### CROSS-REFERENCE TO RELATED APPLICATIONS

This application claims priority to: U.S. provisional patent application, Ser. No. 60/833,524, filed on Jul. 25, 2006; U.S. provisional patent application, Ser. No. 60/833,988, filed on Jul. 28, 2006; and U.S. provisional patent application, Ser. No. 60/836,535, filed on Aug. 8, 2006. Priority to each of the provisional applications is expressly claimed, and the disclosures of the provisional applications are hereby incorporated herein by reference in their entireties and for all purposes.

### FIELD

The present invention relates generally to mounting systems and more particularly, but not exclusively, to mounting systems suitable for use with user interface devices of vehicle information systems installed aboard passenger vehicles.

### BACKGROUND

Vehicles, such as automobiles and aircraft, often include vehicle information systems for satisfying passenger demand for access to viewing content, such as information or entertainment content, while traveling.

Conventional passenger entertainment systems typically include overhead cabin video systems or seat video systems with individual controls such that viewing content is selectable by the passengers. The viewing content can include audio and video materials that are derived from a variety of content sources. Prerecorded viewing content, such as motion pictures and music, can be provided by internal content sources, such as audio and video players, that are installed in the vehicle. The conventional passenger entertainment systems likewise can include an antenna system for receiving viewing content, such as live television programming, transmitted from one or more content providers (or sources) that are external to, and/or remote from, the vehicle.

Several mounting options can exist when the audio and video systems are disposed adjacent to a passenger seat. For example, the seat video system typically is mounted on a facing seatback or within an armrest of the passenger seat. Since the interface point for seatback video system and the interface point for in-arm video system are dissimilar, however, it is not possible to use the same seat video system for both seatback and in-arm installations. Further, the different connector requirements for seatback and in-arm installations result in each type of seat video system having a different mechanical design. Multiple versions of the seat video system therefore must be produced.

In view of the foregoing, a need exists for an improved system and method for mounting user interface devices that overcome the aforementioned obstacles and deficiencies of conventional mounting systems.

### BRIEF DESCRIPTION OF THE DRAWINGS

FIG. 1 is an exemplary top-level drawing illustrating an embodiment of a mounting system for a user interface device.

FIG. 2 is an exemplary detail drawing illustrating the mounting system of FIG. 1, wherein the mounting system includes a docking system and an installation system.

FIGS. 3A-B are exemplary detail drawings illustrating an embodiment of the user interface device of FIG. 1, wherein the user interface device includes a video presentation system, an audio presentation system, and an input system.

FIG. 4A is an exemplary detail drawing illustrating the mounting system of FIG. 2, wherein the user interface device of FIGS. 3A-B is received by the docking system.

FIG. 4B is an exemplary detail drawing illustrating the mounting system of FIG. 4A, wherein the user interface device is engaged by the docking system.

FIG. 4C is an exemplary detail drawing illustrating the mounting system of FIG. 4B, wherein the user interface device is supported by the installation system.

FIG. 5A is an exemplary top-level drawing illustrating the user interface device of FIGS. 3A-B, wherein the user interface device is incorporated into a vehicle information system installed aboard an automobile.

FIG. 5B is an exemplary top-level drawing illustrating the user interface device of FIGS. 3A-B, wherein the user interface device is incorporated into a vehicle information system installed aboard an aircraft.

FIG. 6 is an exemplary detail drawing illustrating one preferred embodiment of a distribution system for the vehicle information systems of FIGS. 5A-B.

FIG. 7A is an exemplary top-level drawing illustrating an embodiment of the vehicle information systems of FIGS. 5A-B, wherein the mounting system couples the user interface device with a suitable surface within a passenger cabin.

FIG. 7B is an exemplary top-level drawing illustrating an alternative embodiment of the vehicle information systems of FIGS. 5A-B, wherein the mounting system couples the user interface device with a passenger seat within a passenger cabin.

FIG. 8A is an exemplary top-level drawing illustrating an embodiment of the mounting system of FIG. 7B, wherein the docking system is partially integrated with the installation system.

FIG. 8B is an exemplary detail drawing illustrating the mounting system of FIG. 8A.

FIG. 8C is an exemplary detail drawing illustrating the mounting system of FIG. 8A, wherein the user interface device is engaged by a docking system of the mounting system.

FIG. 9A is an exemplary top-level drawing illustrating an alternative embodiment of the mounting system of FIG. 7B, wherein the docking system is fully integrated with the installation system.

FIG. 9B is an exemplary detail drawing illustrating the mounting system of FIG. 9A.

FIG. 9C is an exemplary detail drawing illustrating the mounting system of FIG. 9A, wherein the user interface device is engaged by a docking system of the mounting system.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not illustrate every aspect of the present invention and do not limit the scope of the invention.

### DETAILED DESCRIPTION OF THE PREFERRED EMBODIMENTS

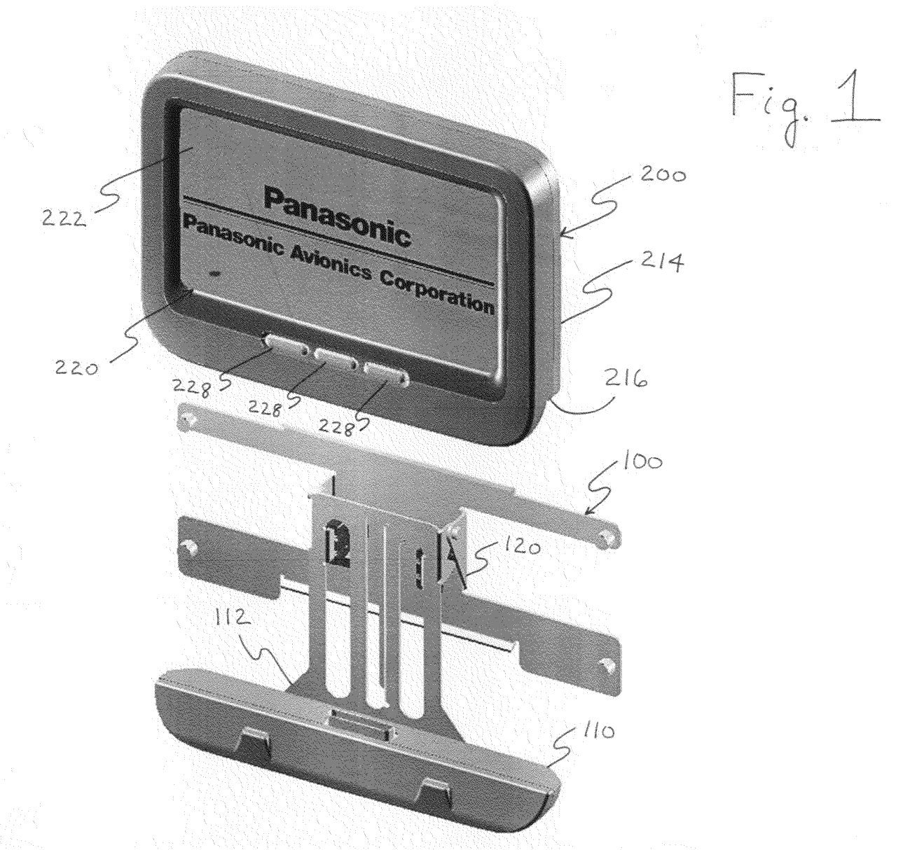

Since currently-available mounting systems require production of multiple versions of each user interface device, an improved mounting system that enables a user interface device to be compatible, without modification, with each of the mounting options associated with passenger seats can prove desirable and provide a basis for a wide range of system applications, such as vehicle information systems for use aboard automobiles, aircraft, and other types of vehicles. This result can be achieved, according to one embodiment disclosed herein, by a mounting system 100 as illustrated in FIG. 1.

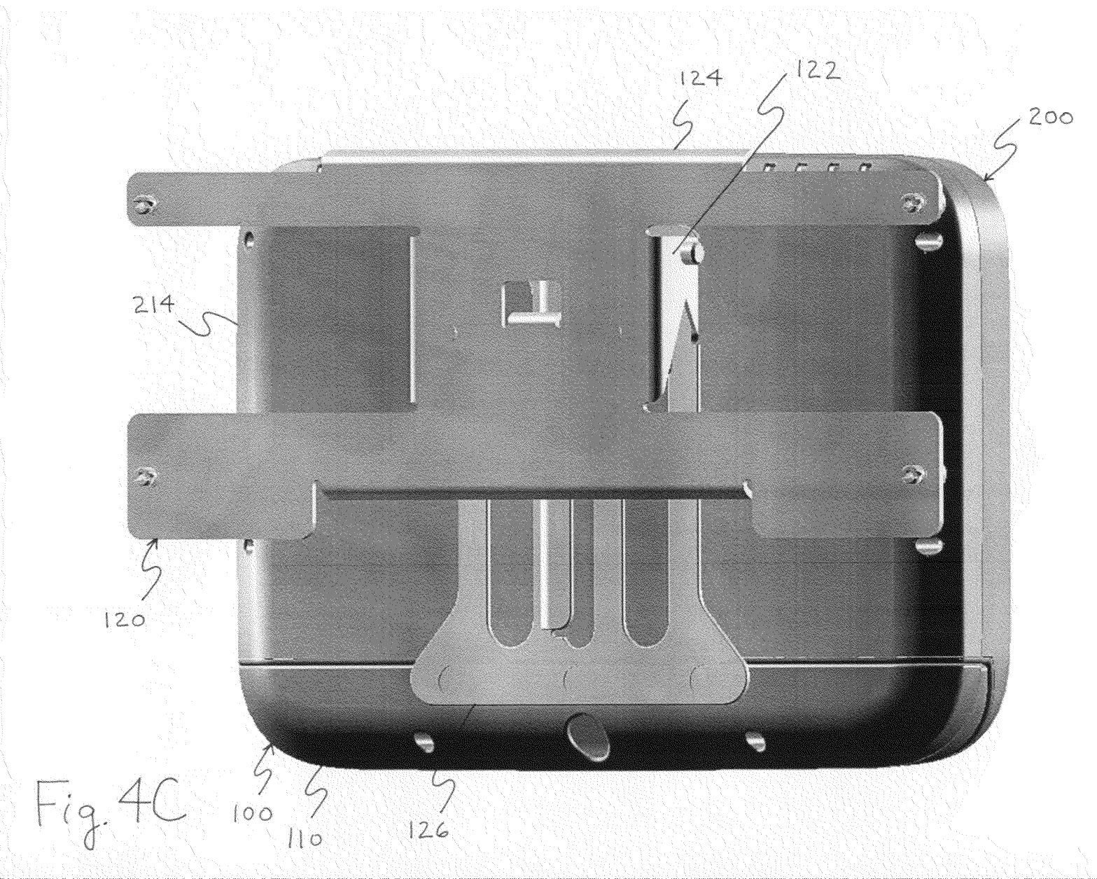

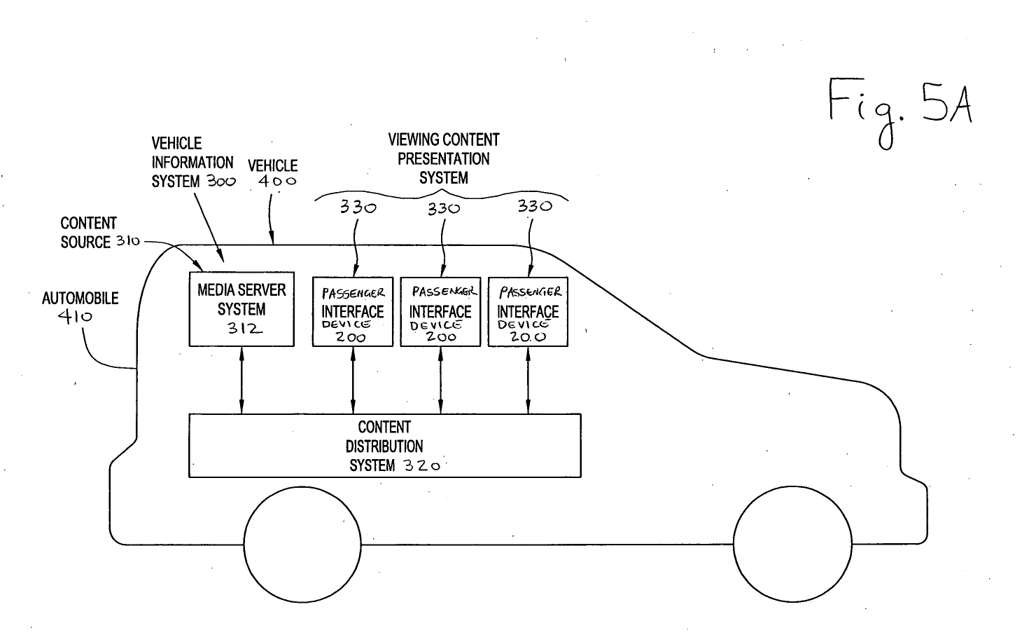

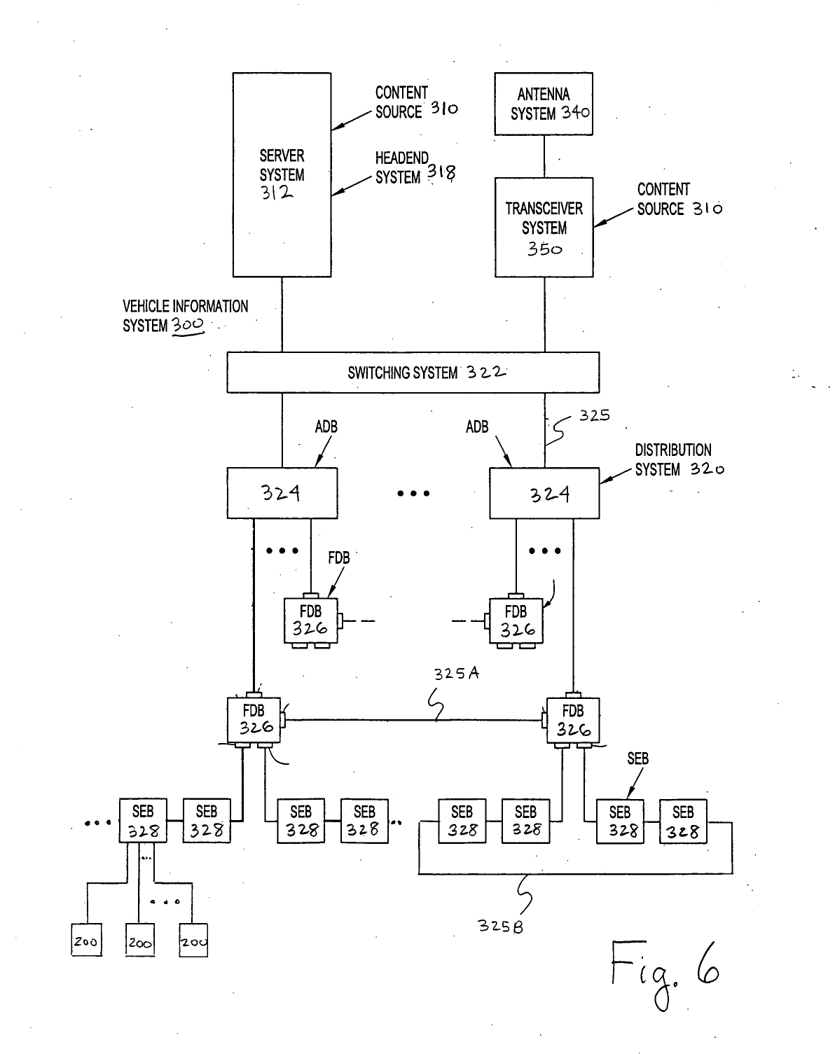

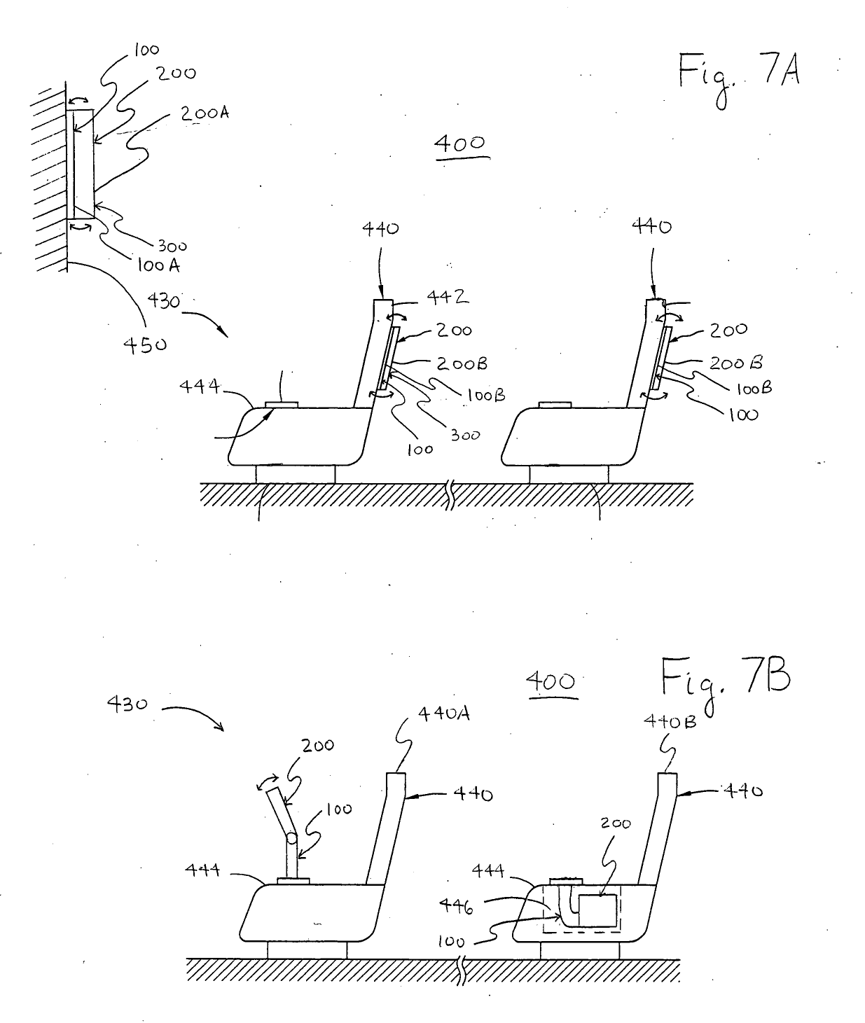

Turning to FIG. 1, the mounting system 100 is configured for use with a user (or passenger) interface device 200. The mounting system 100 can be installed at a suitable stationary location, such as a building, and/or can be used in portable applications, such as within a passenger cabin 430 (shown in FIGS. 7A-B) of a passenger vehicle 400 (shown in FIGS. 5A-B). Once properly installed, the mounting system 100 can receive and engage the passenger interface device 200. The passenger interface device 200 thereby can select and present viewing content and, when not in use, can be stowed in a manner that does not interfere with the user (or passenger). As desired, the mounting system 100 can support communications among one or more passenger interface devices 200 and/or available content sources 310 (shown in FIGS. 5A-B). Each passenger interface device 200 likewise can select and present viewing content provided by another passenger interface device 200 and/or a selected content source 310.

Advantageously, the mounting system 100 and the passenger interface device 200 are provided as modular units, enabling a malfunctioning passenger interface device 200 to be easily removed from the mounting system 100 and replaced with another passenger interface device 200. The malfunction thereby can be readily addressed with minimal inconvenience to the user, and the malfunctioning passenger interface device 200 can be discarded and/or repaired at a later time. Alternatively, and/or in addition, the passenger interface device 200 can be provided as a handheld unit and can be removable from the mounting system 100 for use. Further, since the passenger interface devices 200 are produced with a common form factor, each passenger interface device 200 thus can, without modification, be received by, and engaged by, any mounting system 100 installed in the building and/or vehicle 400. Thereby, only one version of the passenger interface device 200 can be produced, purchased, and/or inventoried.

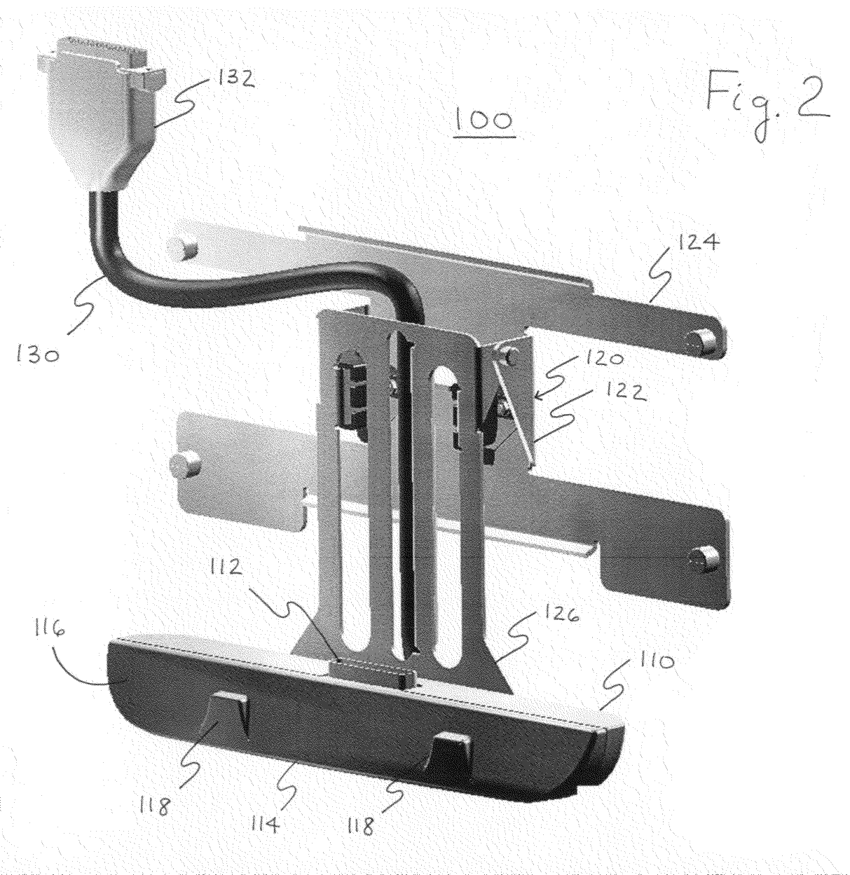

The mounting system 100 can include a docking system 110 and an installation system 120 as illustrated in FIG. 2. The docking system 110 enables the passenger interface device 200 (shown in FIG. 1) to couple with the mounting system 100; whereas, the installation system 120 provides a mechanism for installing the mounting system 100 at a predetermined location. The docking system 110 includes an enclosure (or housing) 114 that is formed to cooperate with an enclosure (or housing) 214 (shown in FIG. 1) of the passenger interface device 200. For example, the housing 214 of the passenger interface device 200 can include a recessed housing region (or surface) 216 (shown in FIG. 1) for receiving a projected housing region (or surface) 116 of the housing 114 of the docking system 110. Although shown and described with reference to the recessed housing region 216 that receives the projected housing region 116 for purposes of illustration only, the housing 114 of the docking system 110 and the housing 214 of the passenger interface device 200 can cooperate in any conventional manner.

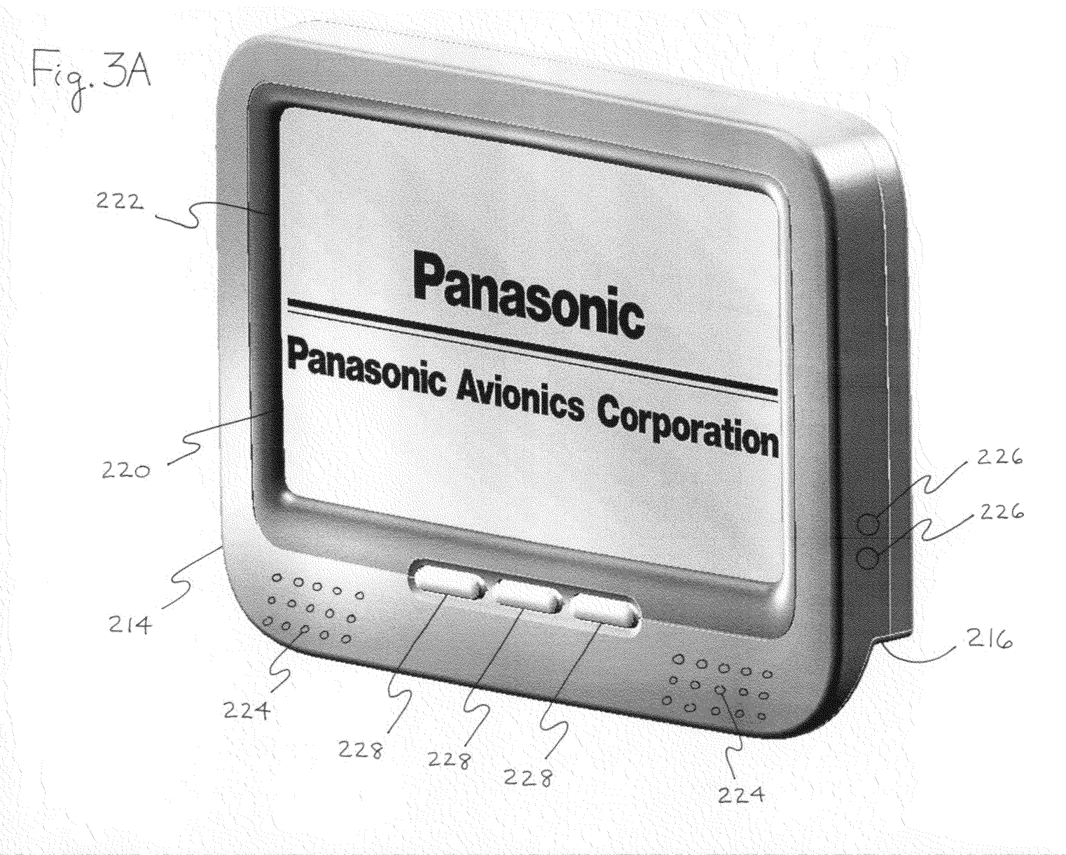

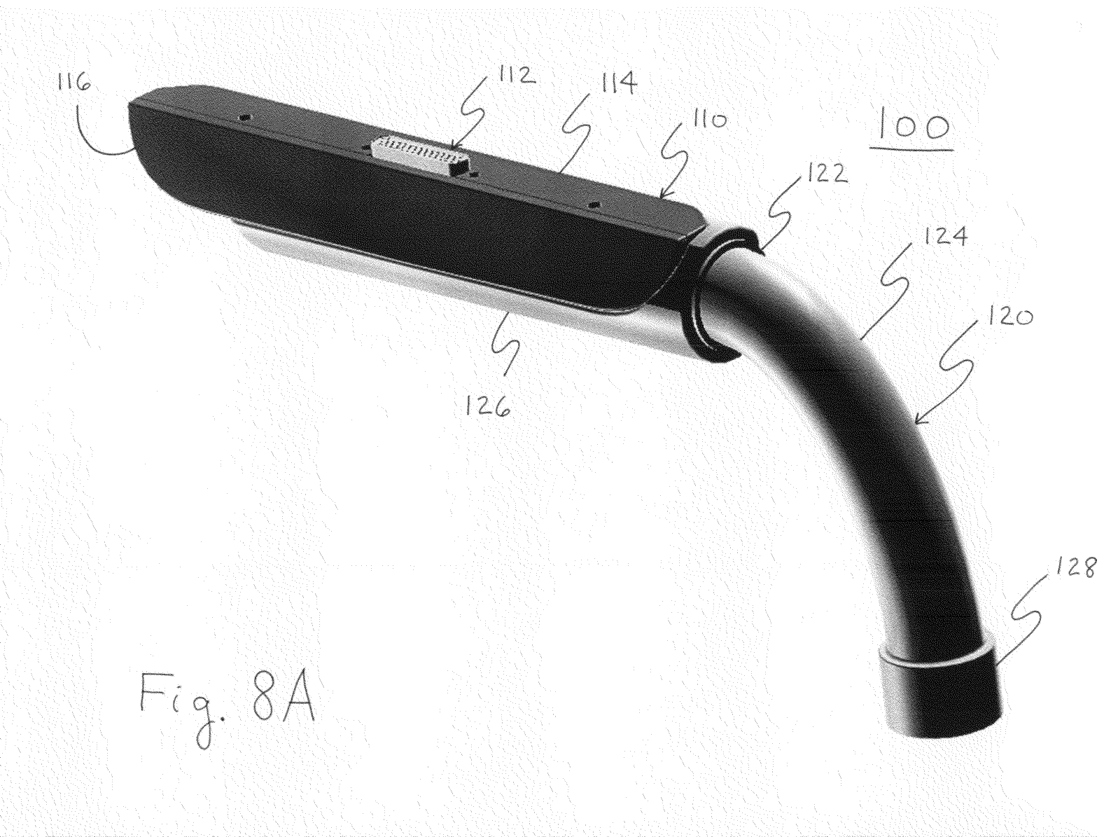

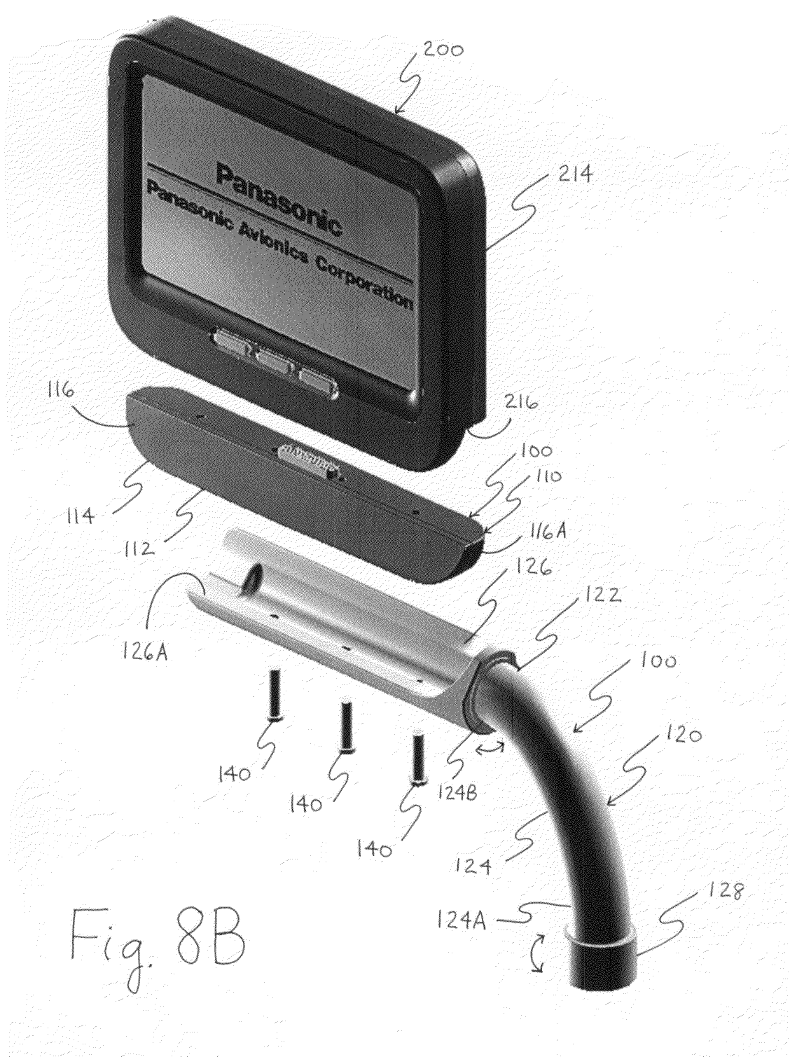

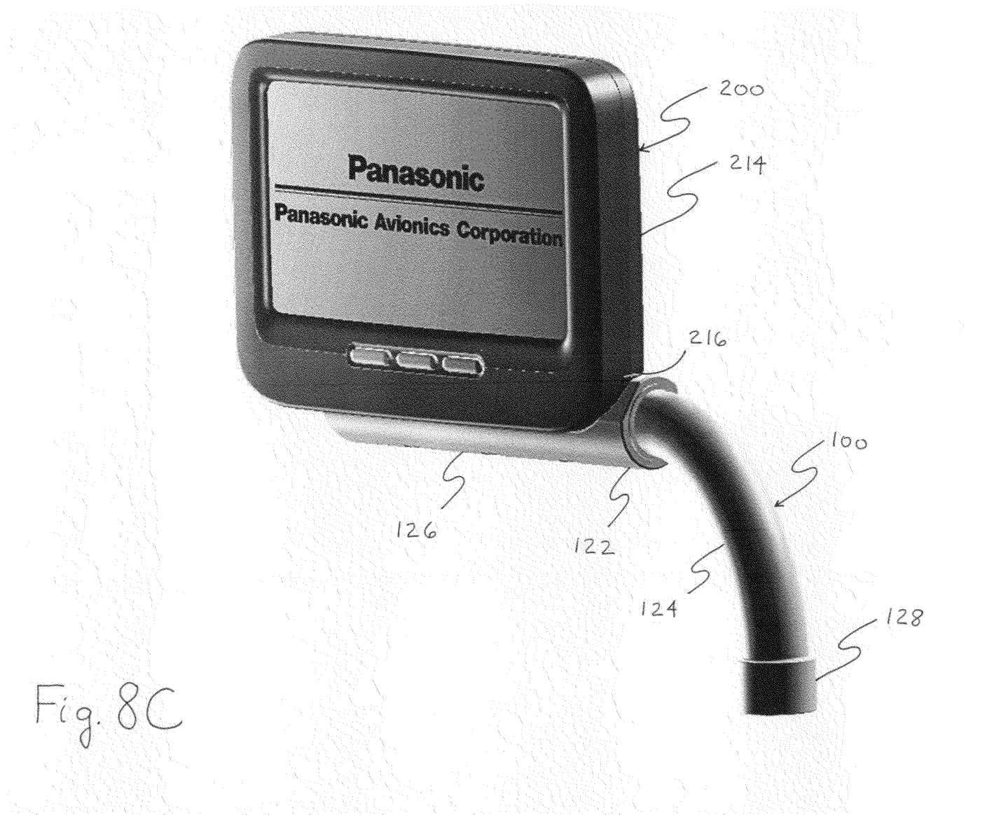

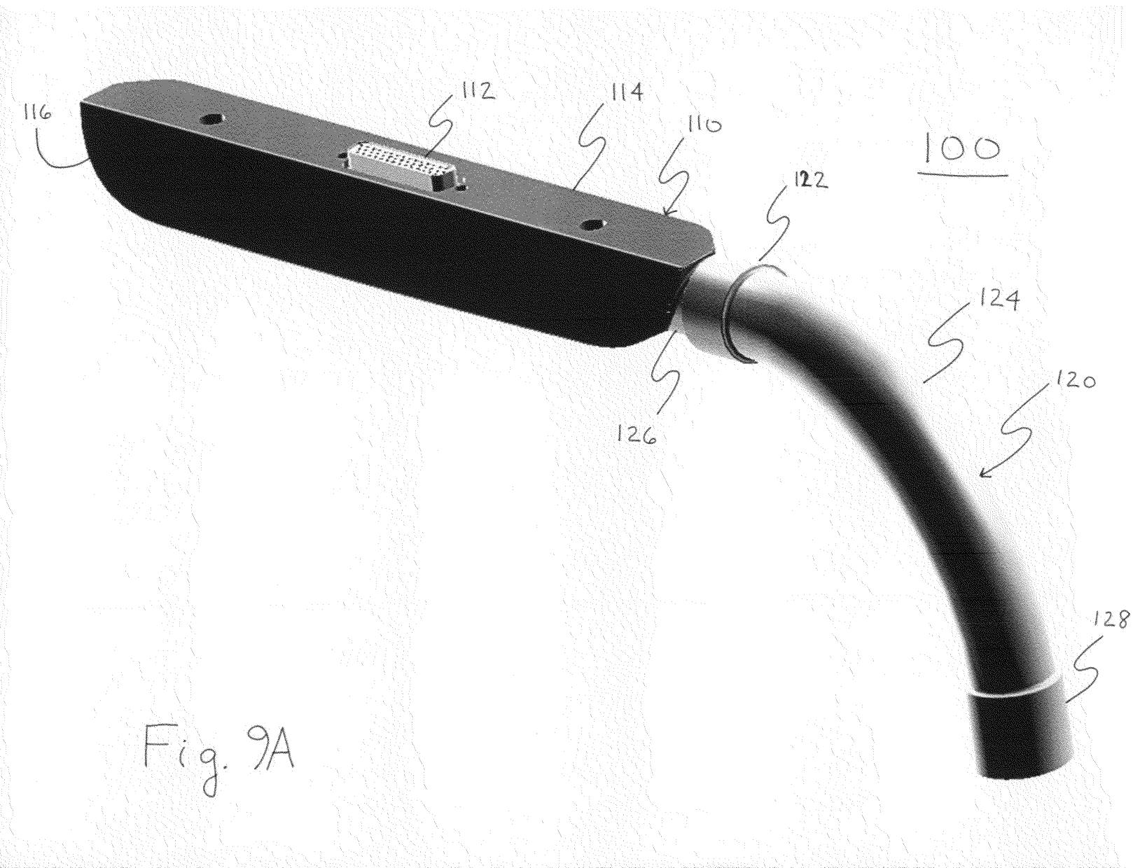

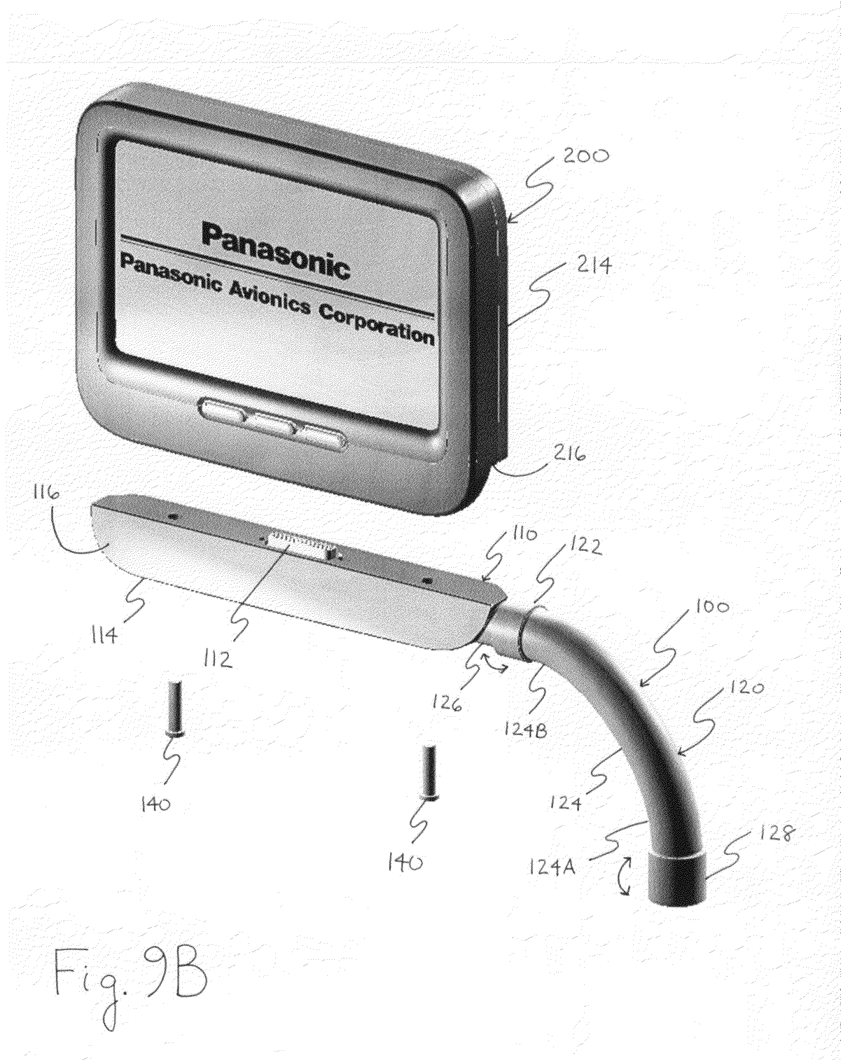

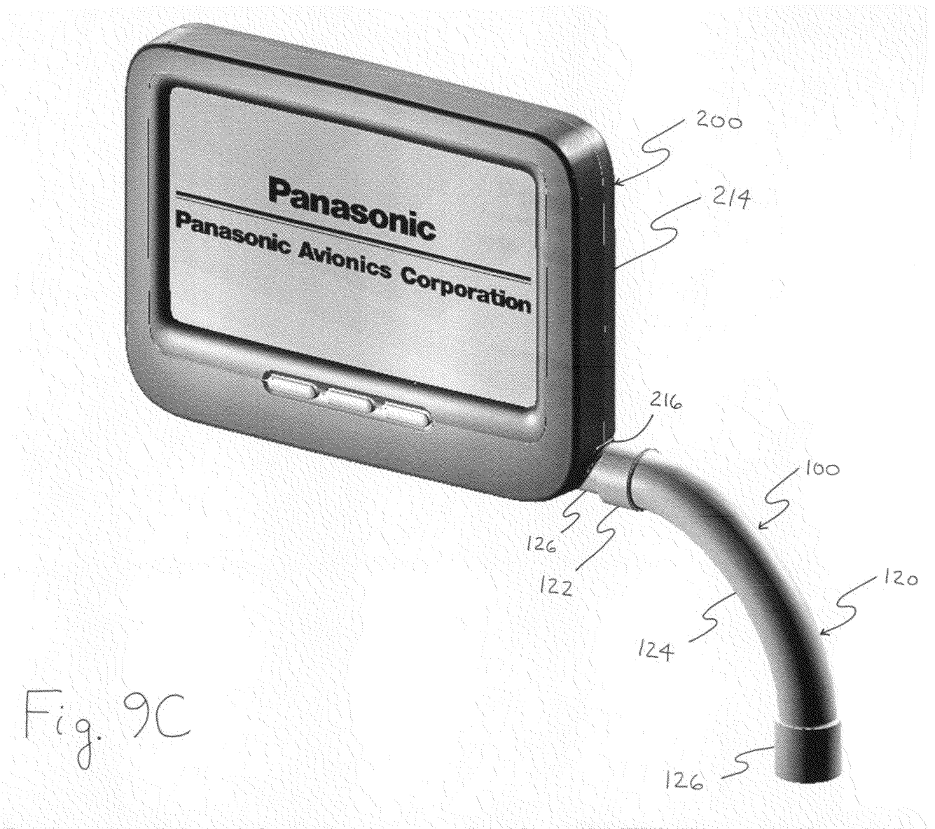

To facilitate the engagement between the docking system 110 and the received passenger interface device 200, the housing 114 of the docking system 110 and the housing 214 of the passenger interface device 200 preferably include one or more sets of cooperating detents 118, 218 (shown in FIG. 3B) for facilitating the engagement between the docking system 110 and the received passenger interface device 200. The term “detents” refers to any combination of mating elements, such as blocks, tabs, pockets, slots, ramps, locking pins, cantilevered members, support pins, and the like, that may be selectively or automatically engaged and/or disengaged to couple or decouple the housings 114, 214 relative to one another. It will be appreciated that the cooperating detents as illustrated and described below are merely exemplary and not exhaustive. The passenger interface device 200 thereby can be received and engaged by the mounting system 100 and, as desired, readily removed from the mounting system 100. As desired, the docking system 110 and the received passenger interface device 200 can be more securely coupled via one or more fasteners 140 (shown in FIGS. 8B, 9B), such as screws.

Although the received passenger interface device 200 can be configured to directly communicate with one or more external systems (or devices), such as another passenger interface device 200 and/or an available content source 310 (shown in FIGS. 5A-B), the docking system 110 advantageously can include a communication port (or connector) 112 for supporting communications between the passenger interface device 200 and the external systems via the mounting system 100. The communication port 112 can comprise any conventional type of communication port and can be configured to cooperate with a communication port (or connector) 222 (shown in FIG. 3B) of the passenger interface device 200. Thereby, the received passenger interface device 200 and the external systems can communicate via the docking system 110 in any conventional manner, including via wired communications and/or wireless communications, as set forth the above-referenced co-pending U.S. patent applications, “SYSTEM AND METHOD FOR DOWNLOADING FILES,” Ser. No. 10/772,565, filed on Feb. 4, 2004; “PORTABLE MEDIA DEVICE AND METHOD FOR PRESENTING VIEWING CONTENT DURING TRAVEL,” Ser. No. 11/154,749, filed on Jun. 15, 2005; “SYSTEM AND METHOD FOR MANAGING CONTENT ON MOBILE PLATFORMS,” Ser. No. 11/123,327, filed on May 6, 2005; and “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005, which are assigned to the assignee of the present application and the respective disclosures of which are hereby incorporated herein by reference in their entireties.

If the mounting system 100 supports wired communications between the received passenger interface device 200 and the external systems, for example, the communication port 112 of the docking system 110 can be connected with a conventional cable assembly 130, such as a cable harness. The cable assembly 130 can be terminated with a suitable communication connector (or port) 132 for coupling the mounting system 100 with the external systems. As desired, the mounting system 100 and the external systems can communicate directly and/or indirectly via an intermediate network, such as a content distribution system 320 (shown in FIGS. 5A-B). The received passenger interface device 200 and the external systems thereby can communicate via the mounting system 100.

The mounting system 100 is shown in FIG. 2 as being configured for installation at a selected mounting surface 450 (shown in FIG. 7A). Illustrative mounting surfaces can include a wall and/or a ceiling in a building as well as a wall, a ceiling, a bulkhead, and/or a seatback 442 (shown in FIG. 7A) in a passenger vehicle 400 (shown in FIGS. 5A-B). To install the mounting system 100 at the mounting surface 450, the installation system 120 of the mounting system 100 is configured to couple with the mounting surface 450. The installation system 120 can couple with the mounting surface 450 in any conventional manner, including via at least one fastener, at least one cooperating detent, and/or bonding via, for example, use of welding and/or an adhesive. As desired, the installation system 120 can be installed over, and/or disposed (or recessed) at least partially within, the mounting surface 450. Once the installation system 120 is coupled with the mounting surface 450, the passenger interface device 200 can be received and engaged by the mounting system 100.

As desired, the docking system 110 and the installation system 120 can be provided as a single integrated unit or, as shown in FIG. 2, as separate systems. If provided as separate systems, the docking system 110 and the installation system 120 can be coupled in any conventional manner, including any manner of fixed and/or adjustable coupling. The installation system 120 of FIG. 2, for example, is shown as comprising first and second installation members 124, 126 with an intermediate position adjustment system 122. The first installation member 124 provides a mechanism for installing the mounting system 100 at a preselected surface; whereas, the second installation member 126 is shown as being fixedly coupled with the docking system 110. In addition to coupling the docking system 110 with the installation system 120, the second installation member 126 advantageously provides support for the passenger interface device 200 received by the mounting system 100. The docking system 110 likewise can include a support member (not show) for supporting for the received passenger interface device 200.

The first and second installation members 124, 126 are coupled via the position adjustment system 122. The position adjustment system 122 can be of any conventional design and is illustrated in FIG. 2 as being a tilt mechanism. As shown in FIG. 2, the position adjustment system 122 permits an angle formed between the first and second installation members 124, 126 to be adjustable within a predetermined range of angles. The predetermined range of angles, for instance, can include a continuous range of angles and/or discrete angles within the range. The position adjustment system 122 thereby enables adjustable positioning of the received passenger interface device 200 as disposed within the mounting system 100. Although shown and described as a rotation about one axis for purposes of illustration only, the position adjustment system 122 can provide any conventional type of adjustment between the first and second installation members 124, 126, including linear displacements in one or more dimensions and/or angular displacements about one or more axes.

An exemplary embodiment of the passenger interface device 200 is shown in FIGS. 3A-B. The passenger interface device 200 includes a content presentation system 220 for presenting selected viewing content (not shown). The viewing content can comprise any conventional type of audible and/or visible viewing content, such as stored (or time-delayed) viewing content and/or live (or real-time) viewing content, in the manner set forth in the above-referenced co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005, which applications were incorporated herein by reference above.

As desired, the viewing content can include geographical information in the manner set forth in U.S. Pat. No. 6,661,353, entitled “METHOD FOR DISPLAYING INTERACTIVE FLIGHT MAP INFORMATION,” which is assigned to the assignee of the present application and the disclosure of which is hereby incorporated herein by reference in its entirety. Alternatively, and/or in addition to entertainment content, such as live satellite television programming and/or live satellite radio programming, the viewing content likewise can include two-way communications such as real-time access to the Internet 316 (shown in FIG. 5B) and/or telecommunications in the manner set forth in U.S. Pat. No. 5,568,484, entitled “TELECOMMUNICATIONS SYSTEM AND METHOD FOR USE ON COMMERCIAL AIRCRAFT AND OTHER VEHICLES,” which is assigned to the assignee of the present application and the disclosure of which is hereby incorporated herein by reference in its entirety. It is understood that the exemplary viewing content as shown and described herein are not exhaustive and are provided herein for purposes of illustration only and not for purposes of limitation.

The viewing content can be selected from viewing content stored internally within the passenger interface device 200 and/or provided by a source, such as another passenger interface device 200 and/or a selected content source 310 (shown in FIGS. 5A-B), external to the passenger interface device 200. Illustrative passenger interface devices 200 are shown and described in the co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005, which applications were incorporated herein by reference above.

As illustrated in FIGS. 3A-B, the content presentation system 220 can include a video presentation system 222 for visually presenting a video portion of the viewing content and an audio presentation system for audibly presenting an audio portion of the viewing content. The video presentation system 222 can be provided in any conventional manner. For example, the passenger interface device 200 can comprise a seat video system for use with a vehicle information system 300 (shown in FIGS. 5A-B). The video presentation system 222 can have a viewing screen with an appropriately-sized viewable area with sufficient resolution for visually presenting the viewing content. Illustrative video resolutions for presenting viewing content can include any color graphics adapter (CGA) resolution, enhanced graphics adapter (EGA) resolution, video graphics array (VGA) resolution, extended graphics array (XGA) resolution, super extended graphics array (SXGA) resolution, ultra extended graphics array (UXGA) resolution, and/or wide graphics array (WXGA) resolution.

Alternatively, and/or in addition, the passenger interface device 200 can be provided as a handheld device, such as a personal media device, a laptop computer, a palmtop computer, a personal digital assistant (PDA), cellular telephone, and/or a MPEG Audio Layer 3 (MP3) device in the manner disclosed in the above-referenced co-pending U.S. patent applications, entitled “SYSTEM AND METHOD FOR DOWNLOADING FILES,” Ser. No. 10/772,565, filed on Feb. 4, 2004; and entitled “PORTABLE MEDIA DEVICE AND METHOD FOR PRESENTING VIEWING CONTENT DURING TRAVEL,” Ser. No. 11/154,749, filed on Jun. 15, 2005, which applications were incorporated herein by reference above. The audio presentation system can be provided in any conventional manner, such as via one or more integrated speaker systems 224 and/or audio communication ports 226. The audio ports 226 enable the audio viewing content to be presented via a peripheral audio system, such as headphones and/or an external speaker system.

The passenger interface device 200, as desired, can include an input system 228 for selecting the viewing content and/or controlling the presentation of the selected viewing content. Although shown in FIG. 3A as comprising one or more switches (or pushbuttons), such as a keyboard or a keypad, the input system 228 can be provided in any conventional manner and can include a pointing device (not shown), such as a mouse, trackball, or stylus. As desired, the input system 228 can be at least partially integrated with, and/or separable from, the passenger interface device 200. The input system 228 likewise can include one or more communication ports (not shown) for coupling a peripheral input device (not shown), such as a full-size computer keyboard, an external mouse, and/or a game pad, with the passenger interface device 200. As desired, the input system 228 can be at least partially combined with the video presentation system 222. The input system 228 thereby can comprise a touchscreen system and/or a menu system for selecting viewing content.

In the manner set forth above, the passenger interface device 200 is disposed within an enclosure (or housing) 214. Each passenger interface device 200 preferable is produced with a common form factor and can, without modification, be received by, and engaged by, any mounting system 100 (shown in FIG. 1) installed in the building and/or vehicle 400 (shown in FIGS. 5A-B). Thereby, only one version of the passenger interface device 200 needs to be produced, purchased, and/or inventoried. The housing 214 of each passenger interface device 200 is shown as including a recessed housing region 216 for receiving at least a portion, such as the projected housing region (or surface) 116 (shown in FIG. 2), of the housing 114 (shown in FIG. 2) of the docking system 110 (shown in FIG. 2).

Further, even if several versions of the passenger interface device 200 are desired, the housings 214 of each version can include uniform recessed housing regions 216 for receiving the docking system 110. For example, two versions of the passenger interface devices 200 can be produced: one version having a housing 214 with large overall housing dimensions to accommodate a large viewing screen; and another version having a housing 214 with small overall housing dimensions to accommodate a smaller viewing screen. The housings 214 for each version of the passenger interface devices 200 can advantageously be provided with the uniform recessed housing regions 216. Each version of the passenger interface devices 200 thereby can, without modification, be received by, and engaged by, any mounting system 100 in the manner set forth above.

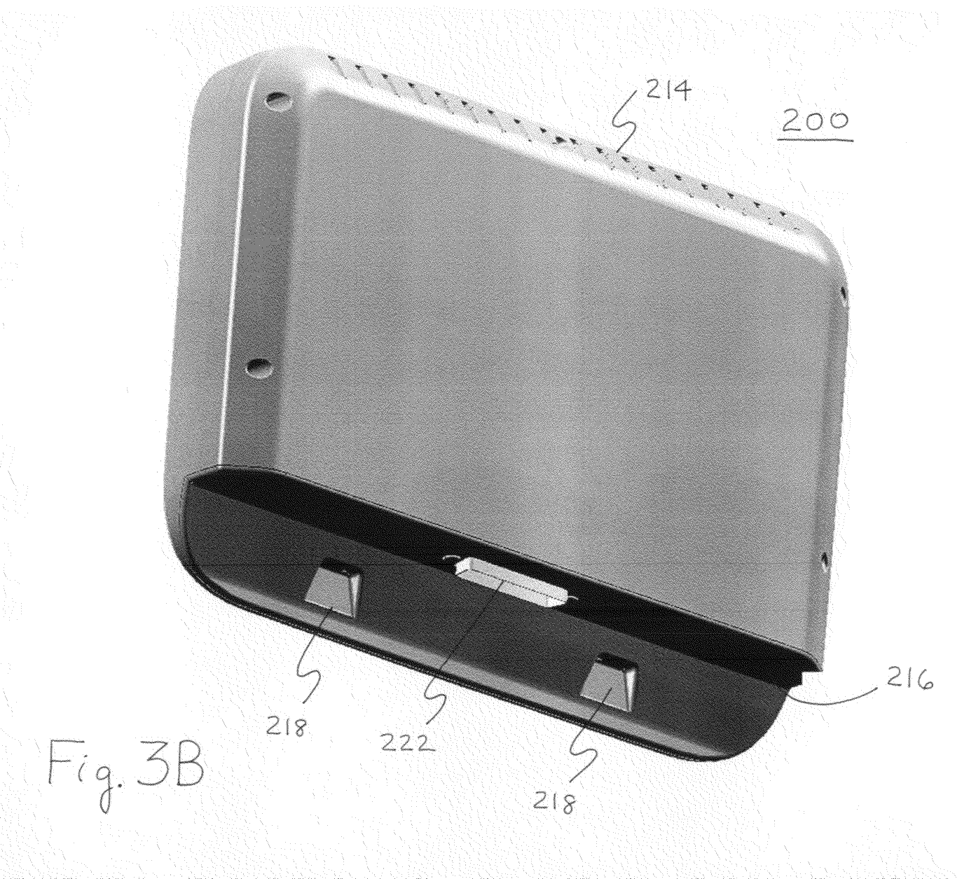

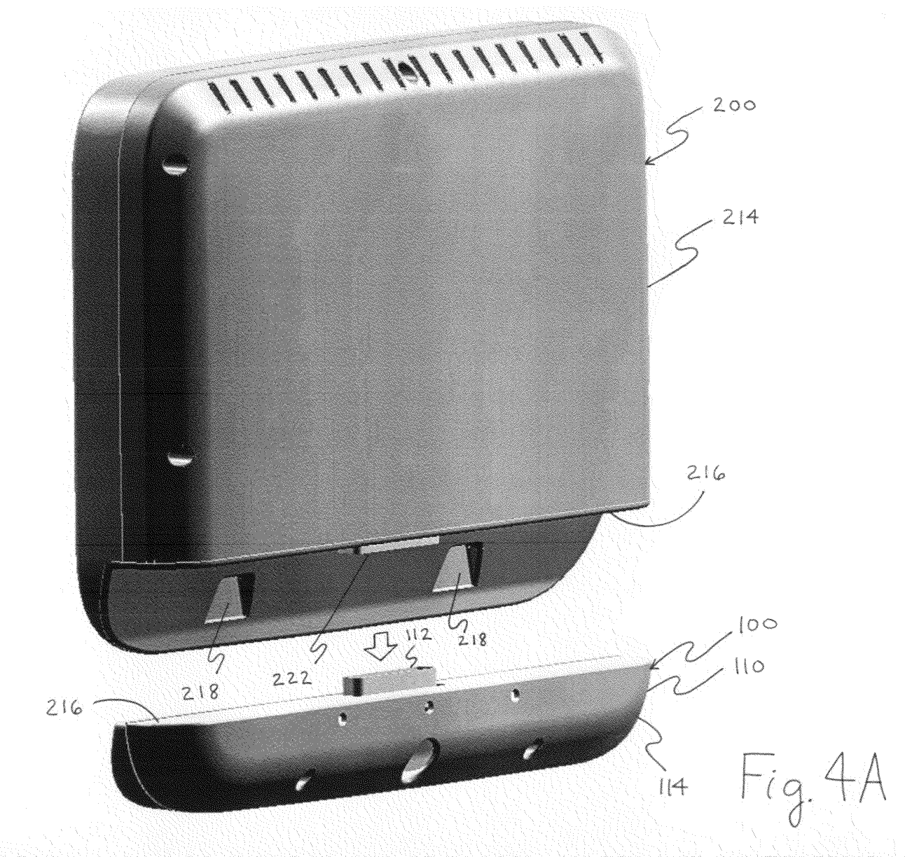

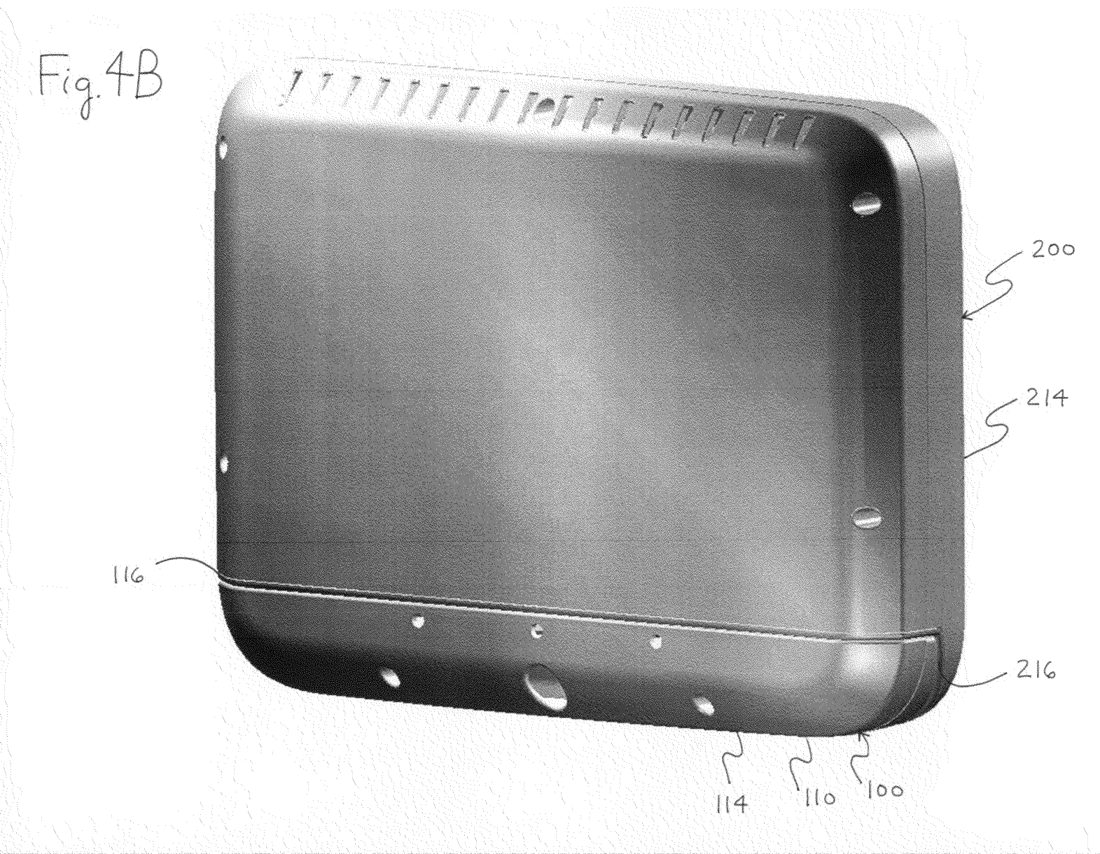

Interaction between the mounting system 100 and the passenger interface device 200 is illustrated in FIGS. 4A-C. When the mounting system 100 has been installed, the passenger interface device 200 can be disposed adjacent to the docking system 110 of the mounting system 100. FIG. 4A shows the passenger interface device 200 approaching the docking system 110. The housing 214 of the passenger interface device 200 begins to receive the housing 114 of the docking system 110. As the housing 214 continues to receive the housing 114, the projected housing region 116 of the docking system 110 is received by the recessed housing region 216 of the passenger interface device 200 in the manner discussed above. The detents 118 (shown in FIG. 2) of the docking system 110 and the detents 218 of the passenger interface device 200 thereby engage, coupling the passenger interface device 200 with the docking system 110 as illustrated in FIG. 4B. FIG. 4C shows the passenger interface device 200 being coupled with the docking system 110 and being supported by the installation system 120. The received passenger interface device 200 can be removed from the mounting system 100 in the reverse manner.

Turning to FIGS. 5A-B, for example, the mounting system 100 and the passenger interface device 200 can be applied in a vehicle information system 300 that can be configured for installation aboard a wide variety of vehicles 400. Exemplary types of vehicles can include an automobile 410 (shown in FIG. 5A), an aircraft 420 (shown in FIG. 5B), a bus, a recreational vehicle, a boat, and/or a locomotive, without limitation. If installed aboard an aircraft 420 as illustrated in FIG. 5B, for example, the vehicle information system 300 can comprise a conventional aircraft passenger in-flight entertainment system, such as the Series 2000, 3000, eFX, and/or eX2 in-flight entertainment system as manufactured by Panasonic Avionics Corporation (formerly known as Matsushita Avionics Systems Corporation) of Lake Forest, Calif.

The vehicle information system 300 can distribute and present viewing content available from one or more content sources 310. Each content source 310 can be provided in any conventional manner, including in the manner set forth in the above-referenced co-pending U.S. patent applications, “SYSTEM AND METHOD FOR DOWNLOADING FILES,” Ser. No. 10/772,565, filed on Feb. 4, 2004; and “PORTABLE MEDIA DEVICE AND METHOD FOR PRESENTING VIEWING CONTENT DURING TRAVEL,” Ser. No. 11/154,749, filed on Jun. 15, 2005, as well as in the co-pending U.S. patent applications, entitled “SYSTEM AND METHOD FOR MANAGING CONTENT ON MOBILE PLATFORMS,” Ser. No. 11/123,327, filed on May 6, 2005; and entitled “SYSTEM AND METHOD FOR RECEIVING BROADCAST CONTENT ON A MOBILE PLATFORM DURING INTERNATIONAL TRAVEL,” Ser. No. 11/269,378, which applications were incorporated herein by reference above. The vehicle information system 300 likewise can receive viewing content from, and/or provide viewing content to, another content source (not shown). In other words, the selected content source 310 can be configured to operate as an intermediate (or relay) system in a larger communication system that includes one or more other content sources 310.

The vehicle information system 300 can include at least one internal content source 310, such as a media server system 312, that is installed aboard the vehicle 400 and/or at least one remote content sources 314, that can be external from the vehicle 400. Being disposed at a headend of the vehicle information system 300, the media server system 312 can provide overall system control functions for the vehicle information systems 300 and/or at least one media (or file) server system for storing preprogrammed content and/or the received viewing content, as desired. The media server system 312 can include, and/or communicate with, one or more conventional peripheral media storage systems (not shown). Exemplary peripheral media storage systems can include optical media devices, such as a digital video disk (DVD) system and/or a compact disk (CD) system, and or magnetic media systems, such as a video cassette recorder (VCR) system and/or a hard disk drive (HDD) system, of any suitable kind, for storing preprogrammed content and/or the received viewing content.

The vehicle information system 300 can communicate with the content sources 310 in any conventional manner, including via wired and/or wireless communications. As shown in FIG. 5B, for example, the vehicle information system 300 can include an antenna system 340 and a transceiver system 350 for communicating with the remote content source 314. The antenna system 340 preferably is disposed outside the vehicle 400, such as on an exterior surface 424 of a fuselage 422 of the aircraft 420. The vehicle information system 300 and the remote content source 410 therefore can communicate in any conventional wireless manner, including directly and/or indirectly via an intermediate communication system 500, such as a satellite communication system 510. As desired, the remote content source 314 can be configured to communicate with other terrestrial content sources (not shown). The remote content source 314 is shown in FIG. 5B as providing access to the Internet 316. Although shown and described as comprising the satellite communication system 510 for purposes of illustration, it is understood that the communication system 500 can comprise any conventional type of wireless communication system, such as a cellular communication system (not shown) and/or an Aircraft Ground Information System (AGIS) communication system (not shown).

One or more seat interface systems 330 are provided for enabling passengers to interact with the vehicle information system 300 during travel. Although the seat interface systems 330 can comprise conventional passenger seat interface systems, the seat interface systems 330 preferably include at least one passenger interface device 200 provided in the manner discussed above. The antenna system 340 and the transceiver system 350 of the vehicle information system 300 is illustrated in FIG. 5B as communicating with the media server system 321 and the passenger interface devices 200 via a distribution system 320. The distribution system 320 can be provided in any conventional manner and is configured to support any conventional type of communications, including wired communications and/or wireless communications.

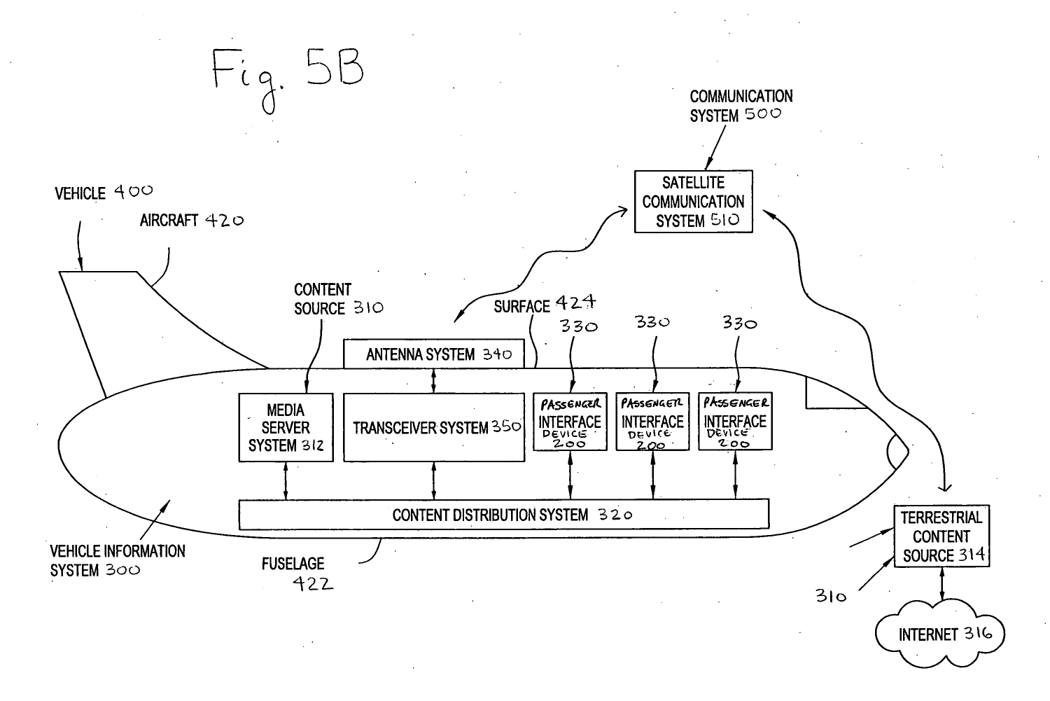

FIG. 6 illustrates an exemplary vehicle information system 300. The vehicle information system 300 is shown in FIG. 6 as including a headend system 318 and a plurality of passenger interface systems 200 that are configured to communicate via a distribution system 320. The headend system 318 can have at least one content source 310, such as a media server system 312 and/or an antenna system 340 and a transceiver system 350 each being provided in the manner set forth in more detail above. The distribution system 320 as shown in FIG. 6 is provided in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006, and in the above-referenced U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES,” which are assigned to the assignee of the present application and the respective disclosures of which are hereby incorporated herein by reference in their entireties. The distribution system 320 thereby can be provided as a plurality of area distribution boxes (ADBs) 324, a plurality of floor disconnect boxes (FDBs) 326, and a plurality of seat electronics boxes (SEBs) (and/or premium seat electronics boxes (PSEBs)) 328 being configured to communicate via a plurality of wired and/or wireless communication connections 325.

As illustrated in FIG. 6, the distribution system 320 can include a switching system 322 for providing an interface between the distribution system 320 and the headend system 318. The switching system 322 can comprise a conventional switching system, such as an Ethernet switching system, and is configured to couple the headend system 318 with the area distribution boxes 324. Preferably, the switching system 322 is coupled with each of the area distribution boxes 324 via a communication connection 325.

As desired, the switching system 322 can be provided as a plurality of interconnected switching sub-systems (not shown). If the switching system 322 is provided as a plurality of interconnected switching sub-systems, each of the switching sub-systems likewise can be configured to communicate with each of the area distribution boxes 324 via a communication connection 325. Each of the area distribution boxes 324, in turn, is coupled with a plurality of floor disconnect boxes 326 via a plurality of communication connections 325. Although the area distribution boxes 324 and the associated floor disconnect boxes 326 can be coupled in any conventional configuration, the associated floor disconnect boxes 326 preferably are disposed in a star network topology about a central area distribution box 324 as illustrated in FIG. 6.

Each floor disconnect box 326 is coupled with, and services, a plurality of daisy-chains of seat electronics boxes 328. Although it will be noted that the number and specific configuration of the seat electronics boxes 328 may be varied from system to system, the floor disconnect box 326 are shown and described with reference to FIG. 6 as being coupled with, and servicing, two daisy-chains of seat electronics boxes 328 for purposes of illustration. Each of the daisy-chains of seat electronics boxes 328 likewise can include any suitable number of seat electronics boxes 328 and is illustrated in FIG. 6 as including two daisy-chained seat electronics boxes 328. The seat electronics boxes 328, in turn, are configured to communicate with the plurality of passenger interface systems 200.

The floor disconnect boxes 326 advantageously can be provided as routing systems and/or interconnected in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. As desired, the distribution system 320 can include at least one FDB internal port bypass connection 325A and/or at least one SEB loopback connection 325B. Each FDB internal port bypass connection 325A is a communication connection 325 that permits floor disconnect boxes 326 associated with different area distribution boxes 324 to directly communicate. Each SEB loopback connection 325B is a communication connection 325 that directly couples the last seat electronics box 328 in each daisy-chain of seat electronics boxes 328 for a selected floor disconnect box 326 as shown in FIG. 6. Each SEB loopback connection 325B therefore forms a loopback path among the daisy-chained seat electronics boxes 328 coupled with the relevant floor disconnect box 326.

FIGS. 7A-B provide a view of a passenger cabin 430 of a passenger vehicle 400, such as the automobile 410 (shown in FIG. 5A) and/or the aircraft 420 (shown in FIG. 5B), aboard which a vehicle information system 300 has been installed. The passenger cabin 430 is illustrated as including a plurality of passenger seats 440, and the passenger seats 440 are associated with passenger interface devices 200. The passenger interface devices 200 are mounted within the passenger cabin 430 via mounting systems 100 and can be configured to present selected viewing content provided via the vehicle information system 300 in the manner discussed in more detail above.

Turning to FIG. 7A, the mounting systems 100 can be provided in the manner set forth above with reference to FIG. 2 and are illustrated as being installed at any suitable surfaces within the passenger cabin 430. Mounting system 100A, for example, is shown as being installed at a cabin surface 450, such as a wall, ceiling, and/or bulkhead. The mounting system 100A therefore can include a docking system 110 (shown in FIG. 2) and an installation system 120 (shown in FIG. 2). The installation system 120 enables the mounting system 100A to be installed at the cabin surface 450; whereas, the docking system 110 can receive and engage passenger interface device 200A, which can comprise an overhead display system. Alternatively, or in addition, mounting systems 100B can be installed at seatbacks 442 of the passenger seats 440. Being provided in the above manner, each mounting system 100B can include a docking system 110 for installing the mounting system 100B at the selected seatback 442 and a docking system 110 for receiving and engaging passenger interface device 200B.

The passenger interface devices 200A, 200B can be provided in the manner discussed above with reference to FIGS. 3A-B. For example, each passenger interface device 200A, 200B can include a video presentation system 222 (shown in FIG. 3A) for visually presenting a video portion of the viewing content. The passenger interface devices 200A, 200B likewise can include an audio presentation system and/or passenger controls for selecting the viewing content and/or controlling the presentation of the selected viewing content. The audio presentation system and/or passenger controls can be provided at armrests 444 of the relevant passenger seats 440 and/or can be integrated into the passenger interface devices 200A, 200B in the manner discussed above with reference to the integrated speaker system 224, audio communication ports 226, and/or the input system 228 (collectively shown in FIG. 3A).

Once properly installed, the mounting systems 100A, 100B can receive and engage the passenger interface devices 200A, 200B as set forth above. Each mounting system 100A, 100B preferably includes a position adjustment system 122 (shown in FIG. 2) for providing adjustable positioning of the received passenger interface devices 200A, 200B as disposed within the respective mounting systems 100A, 100B. The passenger interface devices 200A, 200B thereby can select and present viewing content and, when not in use, can be stowed in a manner that does not interfere with the passenger. If provided as handheld units, the received passenger interface devices 200A, 200B likewise can be removed from the mounting systems 100A, 100B for use.

A malfunctioning passenger interface device 200 advantageously can be easily removed from the mounting system 100A, 100B and replaced with another passenger interface device 200. The malfunction thereby can be readily addressed with minimal inconvenience to the user, and the malfunctioning passenger interface device 200 can be discarded and/or repaired at a later time. Further, the passenger interface devices 200A, 200B are produced with a common form factor and therefore can, without modification, be received by, and engaged by, any mounting system 100A, 100B installed in the building and/or vehicle 400. Only one version of the passenger interface device 200 therefore needs to be produced, purchased, and/or inventoried.

Although shown and described above as being configured for installation at a surface, such as the mounting surface 450 and/or the seatback 442, for purposes of illustration only, the mounting system 100 can be readily configured for installation at any conventional mounting location. The mounting system 100, for example, is illustrated in FIG. 7B as being configured for installation at an armrest 444 of a passenger seat 440. In the manner discussed above with reference to the mounting system 100 of FIG. 1, the mounting system 100 of FIG. 7B, once properly installed, can receive and engage the passenger interface device 200. The mounting system 100 likewise can permit adjustable positioning of the received passenger interface device 200 as disposed within the mounting system 100 as illustrated with the passenger seat 440A. The passenger interface device 200 thereby can select and present viewing content and, when not in use, can be stowed in a manner that does not interfere with the passenger. Passenger seat 440B is shown as including an internal compartment 446 for stowing the passenger interface device 200.

As set forth above, the passenger interface devices 200 are produced with a common form factor. Each passenger interface device 200 therefore can, without modification, be received by, and engaged by, the mounting system 100, including the mounting system 100 of FIG. 2 and/or the mounting system 100 of FIG. 7B. Since the passenger interface devices 200 likewise can be readily removed from the mounting systems 100, a malfunctioning passenger interface device 200 can be replaced with another passenger interface device 200 easily and with minimal inconvenience to the user. Further, if provided as a handheld unit, the passenger interface device 200 can be removable from the mounting system 100 for use in the manner discussed in more detail above.

FIGS. 8A-C illustrate one embodiment of the mounting system 100. In the manner set forth in more detail above with reference to the mounting system 100 (shown in FIG. 2), the mounting system 100 can include a docking system 110 and an installation system 120 as illustrated in FIGS. 8A-B. The docking system 110 enables the passenger interface device 200 to couple with the mounting system 100; whereas, the installation system 120 provides a mechanism for installing the mounting system 100 at the armrest 444 (shown in FIG. 7B) of the passenger seat 440 (shown in FIG. 7B). Being provided in the manner discussed above, the docking system 110 includes an enclosure (or housing) 114 that cooperates with the housing 214 of the passenger interface device 200. The docking system 110 likewise can have one or more sets of cooperating detents 118, 218 (shown in FIGS. 2 and 3B) for facilitating the engagement between the docking system 110 and the received passenger interface device 200.

As desired, the docking system 110 and the installation system 120 can be provided as a single integrated unit or, as shown in FIG. 8B, as separate (or partially-integrated) systems. If provided as separate systems, the docking system 110 and the installation system 120 can be coupled in any conventional manner, including any manner of fixed and/or adjustable coupling. For example, the docking system 110 and the installation system 120 are illustrated in FIG. 8B as being coupled via one or more fasteners 140, such as screws. In the manner discussed with reference to the installation system 120 of FIG. 2, the installation system 120 is shown in FIGS. 8A-B as comprising first and second installation members 124, 126 with an intermediate position adjustment system 122. The first installation member 124 provides a mechanism for installing the mounting system 100 at the armrest 444; whereas, the second installation member 126 is shown as being coupled with the docking system 110.

The second installation member 126 preferably is formed to cooperate with the housing 114 of the docking system 110. For example, the second installation member 126 is illustrated as forming a recessed member region 126A. The recessed member region 126A can be provided in the manner discussed above with reference to the recessed housing region (or surface) 216 (shown in FIG. 1) and is formed to receive and engage a second projected housing region (or surface) 116A of the housing 114 of the docking system 110. The engagement between the docking system 110 and the second installation member 126 can be facilitated via one or more sets of cooperating detents 118, 218 (shown in FIGS. 2 and 3B) and/or, as shown in FIG. 8B, one or more fasteners 140, such as screws. Although shown and described with reference to the recessed member region 126A that receives the second projected housing region 116A for purposes of illustration only, the docking system 110 and the second installation member 126 can cooperate in any conventional manner.

The first installation member 124 is shown as being an arched, elongate member with proximal and distal end regions 124A, 124B. The proximal end region 124A of the first installation member 124 is configured to couple with the armrest 444, and the distal end region 124B can couple with the second installation member 126. The proximal end region 124A can fixedly couple with the armrest 444 and/or, as illustrated in FIG. 8A, can couple with the armrest 444 via an intermediate position adjustment system 128. As shown, the position adjustment system 128 enables the first installation member 124 to rotate relative to the armrest 444 about a first axis of rotation.

In the manner discussed above with reference to the position adjustment system 122 (shown in FIG. 2), the distal end region 124B of the first installation member 124 likewise can be fixedly coupled with the second installation member 126 and/or, as illustrated in FIG. 8A, coupled with the second installation member 126 via an intermediate position adjustment system 122. The second installation member 126 thereby can rotate relative to the first installation member 124 about a second axis of rotation. Although shown and described as a rotation about one axis for purposes of illustration only, the position adjustment systems 122, 128 each can provide any conventional type of adjustment, including linear displacements in one or more dimensions and/or angular displacements about one or more axes. As desired, the second installation member 126 can provide support for the passenger interface device 200 received by the mounting system 100. The docking system 110 likewise can include a support member (not show) for supporting for the received passenger interface device 200.

When the mounting system 100 has been installed at the armrest 444, the passenger interface device 200 can be disposed adjacent to the docking system 110 of the mounting system 100. As the passenger interface device 200 approaches the docking system 110, the housing 214 of the passenger interface device 200 begins to receive the housing 114 of the docking system 110. The housing 214 continues to receive the housing 114, and the projected housing region 116 of the docking system 110 is received by the recessed housing region 216 of the passenger interface device 200 in the manner discussed above until the passenger interface device 200 and the docking system 110 engage as illustrated in FIG. 9C. The position adjustment systems 122, 128 enable adjustable positioning of the received passenger interface device 200 as disposed within the mounting system 100. As desired, the passenger interface device 200 can be secured to the mounting system 100 via the fasteners 140 (shown in FIG. 8B). The received passenger interface device 200 can be removed from the mounting system 100 in the reverse manner.

An alternative embodiment of the mounting system 100 of FIGS. 8A-C is shown in FIGS. 9A-C. As discussed above, the mounting system 100 can include a docking system 110 for enabling the passenger interface device 200 to couple with the mounting system 100 and an installation system 120 for providing a mechanism to install the mounting system 100 at the armrest 444 (shown in FIG. 7B). The docking system 110 and the installation system 120 are illustrated in FIGS. 9A-C as being integrated systems. Being provided in the manner discussed above, the docking system 110 includes an enclosure (or housing) 114 that cooperates with the housing 214 of the passenger interface device 200. The engagement between the docking system 110 and the received passenger interface device 200 can be facilitated via one or more sets of cooperating detents 118, 218 (shown in FIGS. 2 and 3B) and/or fasteners 140 in the manner set forth in more detail above.

As discussed above with reference to the installation system 120 of FIGS. 8A-C, the installation system 120 includes first and second installation members 124, 126 with an intermediate position adjustment system 122. The first installation member 124 provides a mechanism for installing the mounting system 100 at the armrest 444; whereas, the second installation member 126 comprises the docking system 110. Stated somewhat differently, the docking system 110 can be coupled with the first installation member 124 via the position adjustment system 122 and/or can be formed on the second installation member 126. The first installation member 124 and the docking system 110 thereby form an integrated assembly as illustrated in FIGS. 9A-B.

The first installation member 124 of FIGS. 9A-B is an arched, elongate member with a proximal end region 124A for coupling with the armrest 444 and a distal end region 124B for coupling with the docking system 110. As shown in FIG. 9A, the proximal end region 124A can couple with the armrest 444 via an intermediate position adjustment system 128; whereas, the distal end region 124B can couple with the docking system 110 via an intermediate position adjustment system 122. The position adjustment system 128 enables the first installation member 124 to rotate relative to the armrest 444 about a first axis of rotation, and the position adjustment system 122 enables the docking system 110 to rotate relative to the first installation member 124 about a second axis of rotation. As desired, the docking system 110 can provide support for the passenger interface device 200 received by the mounting system 100.

When the mounting system 100 is installed at the armrest 444, the passenger interface device 200 can be disposed adjacent to the docking system 110 of the mounting system 100. The housing 214 of the passenger interface device 200 can receive the housing 114 of the docking system 110, and the projected housing region 116 of the docking system 110 is received by the recessed housing region 216 of the passenger interface device 200 in the manner discussed above until the passenger interface device 200 and the docking system 110 engage as illustrated in FIG. 9C. The position adjustment systems 122, 128 enable adjustable positioning of the received passenger interface device 200 as disposed within the mounting system 100. As desired, the passenger interface device 200 can be secured to the mounting system 100 via the fasteners 140 (shown in FIG. 9B). The received passenger interface device 200 can be removed from the mounting system 100 in the reverse manner.

The invention is susceptible to various modifications and alternative forms, and specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives.

What is claimed is:

1. A system for mounting user interface devices, comprising:
a plurality of mounting systems each including:
an installation system that couples with a predetermined mounting location; and
a docking system adjustably coupled with said installation system via an intermediate position adjustment system, said docking system being disposed in a docking housing with a projected docking housing region and including a docking communication port disposed on said docking housing region, a form factor of said docking housing being uniform among said plurality of said mounting systems; and
a plurality of user interface devices each being disposed in a device housing with a recessed device housing region and including a device communication port disposed within said device housing region, a form factor of said device housing being uniform among said plurality of said user interface devices such that said device housing region of each of said user interface devices can interchangeably receive and engage said docking housing region of each of said mounting systems,
wherein, when a selected user interface device is engaged by a selected mounting system, said device communication port of said selected user interface device and said docking communication port of said selected mounting system communicate, and said selected user interface device presents selected viewing content provided by a content source via said docking system of said selected mounting system.

2. The system of claim 1, wherein said installation system of at least one of said mounting systems adjustably couples with the predetermined mounting location

3. The system of claim 1, wherein said installation system of at least one of said mounting systems couples with a predetermined surface.

4. The system of claim 3, wherein the predetermined surface is selected from a group consisting of a wall, a ceiling, a bulkhead, and a seatback.

5. The system of claim 1, wherein said installation system of at least one of said mounting systems couples with a seat.

6. The system of claim 5, wherein said installation system couples with an armrest of said seat.

7. The system of claim 1, wherein said docking housing region and said device housing region include cooperating detents that facilitate engagement between said selected user interface device and said selected mounting system.

8. The system of claim 1, wherein said selected user interface device is removably engaged by said selected mounting system.

9. The system of claim 1, wherein said selected mounting system supports said selected user interface device.

10. The system of claim 1, wherein said selected user interface device comprises a video presentation system.

11. The system of claim 1, wherein said selected user interface device includes an audio presentation system.

12. The system of claim 1, wherein said selected user interface device includes an input system for selecting viewing content for presentation.

13. The system of claim 1, wherein said selected user interface device comprises a handheld device.

14. The system of claim 1, wherein the selected viewing content provided from the content source to said selected user interface device via a vehicle information system.

15. The system of claim 14, wherein said mounting systems are installed aboard a passenger vehicle.

16. The system of claim 15, wherein said mounting systems are installed aboard an automobile.

17. The system of claim 15, wherein said mounting systems are installed aboard an aircraft.

18. A vehicle information system, comprising:
a distribution system that communicates with a content source;
a plurality of mounting systems each including:
an installation system that couples with a predetermined mounting location; and
a docking system adjustably coupled with said installation system via an intermediate position adjustment system, said docking system being disposed in a docking housing with a projected docking housing region and including a docking communication port disposed on said docking housing region and in communication with said distribution system, a form factor of said docking housing being uniform among said plurality of said mounting systems; and
a plurality of user interface devices each being disposed in a device housing with a recessed device housing region and including a device communication port disposed within said device housing region, a form factor of said device housing being uniform among said plurality of said user interface devices such that said device housing region of each of said user interface devices can interchangeably receive and engage said docking housing region of each of said mounting systems,
wherein, when a selected user interface device is engaged by a selected mounting system, said device communication port of said selected user interface device and said docking communication port of said selected mounting system communicate, and said selected user interface device presents selected viewing content provided by the content source via said docking system of said selected mounting system.

19. The vehicle information system of claim 18, wherein the content source is remote from said distribution system.

20. The vehicle information system of claim 18, wherein the distribution system comprises a wired distribution system.

21. The vehicle information system of claim 18, wherein the distribution system comprises a wireless distribution system.

22. The vehicle information system of claim 18, wherein the vehicle information system is installed aboard an aircraft.

23. A system for mounting user interface devices, comprising:
a mounting system including:
an installation system that couples with a predetermined mounting location; and
a docking system adjustably coupled with said installation system via an intermediate position adjustment system, said docking system being disposed in a docking housing with a docking housing region and including a docking communication port disposed within said docking housing region; and
a user interface device being disposed in a device housing with a device housing region and including a device communication port disposed within said device housing region, said device housing region cooperating with said docking housing region,
wherein, when said user interface device is engaged by said mounting system, said device communication port of said user interface device and said docking communication port of said mounting system communicate, and said user interface device presents selected viewing content provided by a content source via said docking system of said mounting system.

24. A method for mounting user interface devices, comprising:
providing a mounting system including:
an installation system that couples with a predetermined mounting location; and
a docking system adjustably coupled with said installation system via an intermediate position adjustment system, said docking system being disposed in a docking housing with a docking housing region and including a docking communication port disposed within said docking housing region;
providing a user interface device disposed in a device housing with a device housing region and including a device communication port disposed within said device housing region, said device housing region cooperating with said docking housing region;
engaging said user interface device with said mounting system,
forming communications between said device communication port of said user interface device and said docking communication port of said mounting system; and
presenting selected viewing content via said user interface device, the viewing content being provided by a content source via said docking system of said mounting system.

25. An aircraft, comprising:
a fuselage and a plurality of passengers seat arranged within the fuselage; and
a vehicle information system, said vehicle information system coupled with said fuselage and comprising:
a content source;
a distribution system that communicates with said content source;
a plurality of mounting systems each including:
an installation system that couples with a predetermined mounting location within said fuselage; and
a docking system adjustably coupled with said installation system via an intermediate position adjustment system, said docking system being disposed in a docking housing with a projected docking housing region and including a docking communication port disposed on said docking housing region and in communication with said distribution system, a form factor of said docking housing being uniform among said plurality of said mounting systems; and
a plurality of user interface devices each being disposed in a device housing with a recessed device housing region and including a device communication port disposed within said device housing region, a form factor of said device housing being uniform among said plurality of said user interface devices such that said device housing region of each of said user interface devices can interchangeably receive and engage said docking housing region of each of said mounting systems,
wherein, when a selected user interface device is engaged by a selected mounting system, said device communication port of said selected user interface device and said docking communication port of said selected mounting system communicate, and said selected user interface device presents selected viewing content provided by said content source via said docking system of said selected mounting system.
